(19) United States
(12) Patent Application Publication
(10) Pub. No.: US 2025/0292206 A1
(43) Pub. Date: Sep. 18, 2025

(54) SENSOR-ENABLED MARKETPLACE FOR MINED OR RECYCLED MATERIALS

(71) Applicant: X Development LLC, Mountain View, CA (US)

(72) Inventors: Ray Anthony Nagatani Jr., San Francisco, CA (US); Antonio Raymond Papania-Davis, Oakland, CA (US); Weishi Yan, Oakland, CA (US); Shijian Jin, Cambridge, MA (US); Cristian Rodriguez Martinez, San Jose, CA (US)

(21) Appl. No.: 19/070,128

(22) Filed: Mar. 4, 2025

Related U.S. Application Data
(60) Provisional application No. 63/565,112, filed on Mar. 14, 2024.

(51) Int. Cl. G06Q 10/0875; G06Q 50/04; G06T 7/00; G06V 10/74

(52) U.S. Cl. CPC G06Q 10/0875; G06Q 50/04; G06T 7/0004; G06V 10/761; G06T 2207/30108

(57) ABSTRACT

An integrated geomaterials preparation method including receiving, through an API of an integrated geomaterials preparation platform, a raw material request and a set of end-product parameters, determining, from the set of end-product parameters, required characteristics for at least one raw material ingredient to an end product to meet the raw material request, obtaining raw material sensor data from a plurality of raw material sensor systems, identifying, from the raw material sensor data, a particular raw material having characteristics similar to the required characteristics, where each sensor system is configured to scan and characterize raw materials, generating, using the characteristics of the particular raw material, operational parameters for geomaterial processing equipment to produce a raw material ingredient to meet the raw material request, and providing, the operational parameters to the geomaterial processing equipment, which when executed by the geomaterial processing equipment cause the geomaterial processing equipment to execute the operational parameters.

### CROSS-REFERENCE TO RELATED APPLICATION

This application claims the benefit under 35 U.S.C. § 119 (c) of U.S. Provisional Application No. 63/565,112, filed on Mar. 14, 2024. The disclosure of the prior application is considered part of and is incorporated by reference in the disclosure of this application.

### BACKGROUND

Concrete is the second most consumed substance (by mass) on our planet and is responsible for 7-8% of global CO2 emissions. Concrete's material properties are inconsistent due to the large variation in ingredient material (e.g., aggregates) and processing. This material inconsistency requires large safety margins for a given performance level and results in material overuse. Advances in concrete preparation that can optimize the use of locally available materials to maximize concrete performance while minimizing cost with both traditional and non-traditional concrete ingredients are desirable.

### SUMMARY

This specification describes technologies for an integrated manufacturing platform for enabling an end-to-end product manufacturing cycle between producers of raw and/or recycled materials and a manufacturing facility.

These technologies generally involve systems and methods for integrating an enhanced characterization capacity by raw material producers with flexible manufacturing practices at the manufacturing facility for real-time matching of output raw material characteristics with product demand. The integrated manufacturing platform provides a real-time market-building environment for a manufacturer and raw materials producer(s). The manufacturer provides to the platform a requested set of products-to-be-manufactured and product specifications including, for example, performance parameters (e.g., strength, curing time, composition), cost, environmental impact, and timeframe for the manufacture of the product. The platform can translate each requested product of the set of requested products into one or more corresponding recipes (i.e., multiple recipes may yield the requested product parameters) for manufacture, where the one or more recipes each include a list of ingredients to be sourced from one or more raw material producers. Each ingredient of the recipe includes a set of material characteristics, e.g., specific surface area distribution, composition, volume/weight, reaction state, etc. The raw materials producer(s) can provide a real-time characterized output of raw materials available to the platform, including, for example, volumetric/weight availability, material characteristics, location, cost to produce/ship, and expected time-to-delivery. The characterized output can be extracted using, for example, image data and sensor data (e.g., near-infrared sensor data, hyperspectral data, etc.) to capture and aggregate materials characteristics at pixel level detail. The platform can aggregate all product requests, translate the aggregated product requests into a set of requested raw materials based on recipes meeting product specifications for the requests, and allocate available and/or forecasted material resources meeting the specified product requests in response. Moreover, the platform can provide forecasted material resource demands to the raw materials producers (e.g., volume, quality, composition, etc.), and translate these demands into operational parameters (e.g., crush rate, chemical reaction times, etc.) for processing equipment to output the allocated material resources within the forecasted demand window. For example, during periods where the market volume of demand is low, and transport of the materials is above a threshold cost, then the platform can recommend reduction of output from the raw material producers to minimize overstock of inventory. In another example, the platform can receive requests for raw material having quality control requirements, e.g., threshold mineral content to ensure quality control, and provide to the raw material producers the processing conditions to obtain the threshold mineral content from the extracted raw materials. Additionally, the platform can provide avenues of feedback between real-time product/batching characteristics obtained by the manufacturer to update operational parameters of process equipment to align output of the raw materials within requested specification.

In general, one innovative aspect of the subject matter described in this specification can be embodied in methods for integrated geomaterial preparation including receiving, through an API of an integrated geomaterial preparation platform, a raw material request and a set of end-product parameters. The methods include determining, by the integrated geomaterial preparation platform and from the set of end-product parameters, required characteristics for at least one raw material ingredient to a geomaterial-based end-product to meet the raw material request, obtaining raw material sensor data from multiple raw material sensor systems, and identifying, from the raw material sensor data, a particular raw material having characteristics similar to the required characteristics, where each sensor system is configured to scan and characterize the raw materials. The methods include generating, by the integrated geomaterial preparation platform and using the characteristics of the particular raw material, operational parameters for geomaterial processing equipment to produce the raw material ingredient to meet the raw material request, and providing, by the integrated geomaterial preparation platform, the operational parameters to the geomaterial processing equipment, which when executed by the geomaterial processing equipment cause the geomaterial processing equipment to execute the operational parameters.

Other embodiments of this aspect include corresponding computer systems, apparatus, and computer programs recorded on one or more computer storage devices, each configured to perform the actions of the methods.

The foregoing and other embodiments can each optionally include one or more of the following features, alone or in combination. In particular, one embodiment includes all the following features in combination. In some implementations, the methods further include receiving, through the API of the integrated geomaterial preparation platform, production feedback for a geomaterial-based end-product including the at least one raw material ingredient, where the production feedback includes sensor data from a geomaterial preparation sensor system, identifying, from the sensor data and based on the required characteristics for the at least one raw material ingredient, a deviation of the at least one raw material ingredient in the geomaterial-based end-product from the required characteristics, determining, based on the deviation, an update to the operational parameters to correct the deviation from the required characteristics for an updated production of the at least one raw material ingredient, and providing, to the geomaterial processing equipment, the updated operational parameters, which when executed by the geomaterial processing equipment cause the geomaterial processing equipment to execute the updated operational parameters.

In some implementations, determining required characteristics for the at least one raw material ingredient to a geomaterial-based end-product to meet the raw material request includes, providing, to a trained machine learning model, the set of end-product parameters, obtaining, from the trained machine learning model, a recipe including the at least one raw material ingredient corresponding to a finished product having the set of end-product parameters, and generating, from the recipe, the raw material request for the at least one raw material ingredient.

In some implementations, obtaining raw material sensor data from the plurality of raw material sensor systems includes receiving one or more of image data captured by an optical imaging sensor system and mechanical data captured by a mechanical sensor system.

In some implementations, identifying, from the raw material sensor data, the particular raw material having characteristics similar to the required characteristics includes, for each of the required characteristics: determining, for the required characteristic, that the particular raw material has a corresponding characteristic within a tolerance for the required characteristic.

In some implementations, generating operational parameters for geomaterial processing equipment to produce the raw material ingredient to meet the raw material request includes obtaining, for the geomaterial processing equipment, operating capabilities of the geomaterial processing equipment, and generating control signals that cause the geomaterial processing equipment to update one or more operational parameters within the operating capabilities of the geomaterial processing equipment.

In general, another innovative aspect of the subject matter can be embodied in methods of receiving, through a multi-modal sensing kit, e.g., including, not limited to, hyperspectral imaging or conventional camera systems; performing, on the multi-modal sensor data, computer vision analysis; obtaining, from the computer vision analysis, real-time characterization of ore mineral content and quantity of the raw materials; and matching the characterized ore mineral content and quantity with real-time requirements for product quality.

The subject matter described in this specification can be implemented in particular embodiments so as to realize one or more of the following advantages. An advantage of this technology is that the integrated manufacturing platform can enable direct feedback loops between the raw material producers and end-manufacturer, yielding products having high-standards of quality, lower cost, and reduced environmental impact. In other words, the platform can provide real-time insight into the stock and flow of material, thereby providing useful information for economic simulation and supply and demand prediction in a more explicit manner. For example, the platform can leverage available sensor data from both the raw material producers as well as the end manufacturers to increase visibility to available opportunities for each to expand and optimize their resource usage.

The platform can be used to optimize production output and utilization for both the manufacturer and raw material producers, for example, by incentivizing a characterization-forward operation at the raw material manufacturer, the platform can increase visibility of otherwise wasted materials extracted by the raw materials producers for incorporation into products by the manufacturer and motivate further research and development to improve utilization of available materials. Through aggregation of product requests and an improved understanding of how product parameters translate into raw materials and recipes, the platform may enable improved forecasting of new desired material characteristics and new applications of existing materials, causing raw materials producers to stay up-to-date and accurate in response to market demands.

In some implementations, a product manufacturing process can include multiple entities performing aspects of the process resulting in the end product, where each aspect can yield a sub-product between raw material and end-product. In such cases, the platform can be used to optimize production output and utilization of each sub-product, where a first entity can interact with the platform as a raw material producer for a second entity as well as a manufacturer for a third entity. For example, an ore smelter that outputs a sub-product (e.g., raw steel) can use the platform as manufacturer for a raw ore production facility, as well as interact with the platform as a raw material producer for a steel manufacturer.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A shows an example operating environment for a materials exchange system.

FIG. 1B shows an example block diagram of a process of the materials exchange system.

FIG. 2 is a flow diagram of an example process of the materials exchange system.

FIG. 3 is a flow diagram of an example process of the materials exchange system.

FIG. 4 is a schematic diagram of an example computer system.

Like reference numbers and designations in the various drawings indicate like elements.

### DETAILED DESCRIPTION

Described in this specification is an interactive marketplace platform that integrates high-throughput and rapid optical and chemical characterization of mined geomaterials and recycled materials (e.g., metals, cementitious materials, aggregates from waste) at various points in the mining/recycling process (e.g., input, post-crush, post-reaction, output) to act as an input to a control system to optimize the characteristics of output materials (e.g., size, shape, chemical composition, reaction state) with material/recipe generation technologies that can use output characteristics of scanned materials to recommend recipes and/or specifications for the output materials that optimize target end-state properties of systems composed of the scanned output materials (e.g., concrete systems composed of mined aggregate). Herein, we describe an interactive platform that would enable real-time matching of output end-product characteristics with product demand.

Briefly, this system would include: 1) an API where customers could input desired downstream finished products (e.g., concrete with a certain strength, curing time, and/or cement concentration; a mixture of metal ions to go into a battery) and a desired price, 2) a materials/recipe optimization sub-platform for translating user requirements to desired raw material properties (e.g., size, shape, chemical composition, reaction state) or system recipe, and 3) an API that would call to a control system using scanning technology (e.g., including distributed sensors in a materials preparation setting) and optimize process conditions (e.g., crush rate, chemical reaction times) to maximize matching with real-time market demand based on user prioritization (e.g., total revenue, minimal unused product, total volume sold).

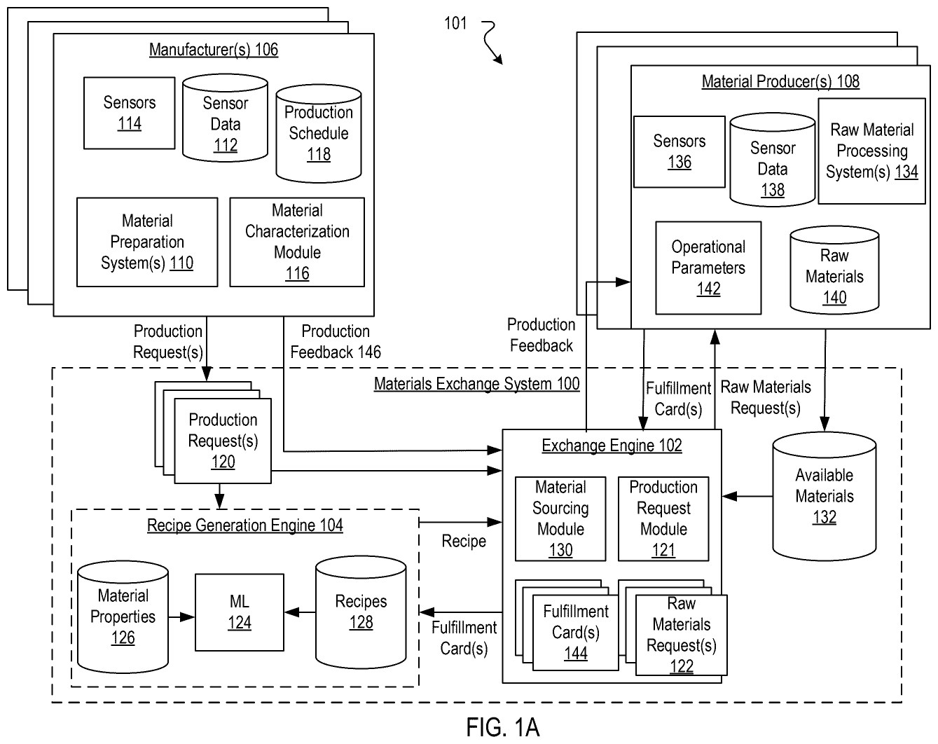

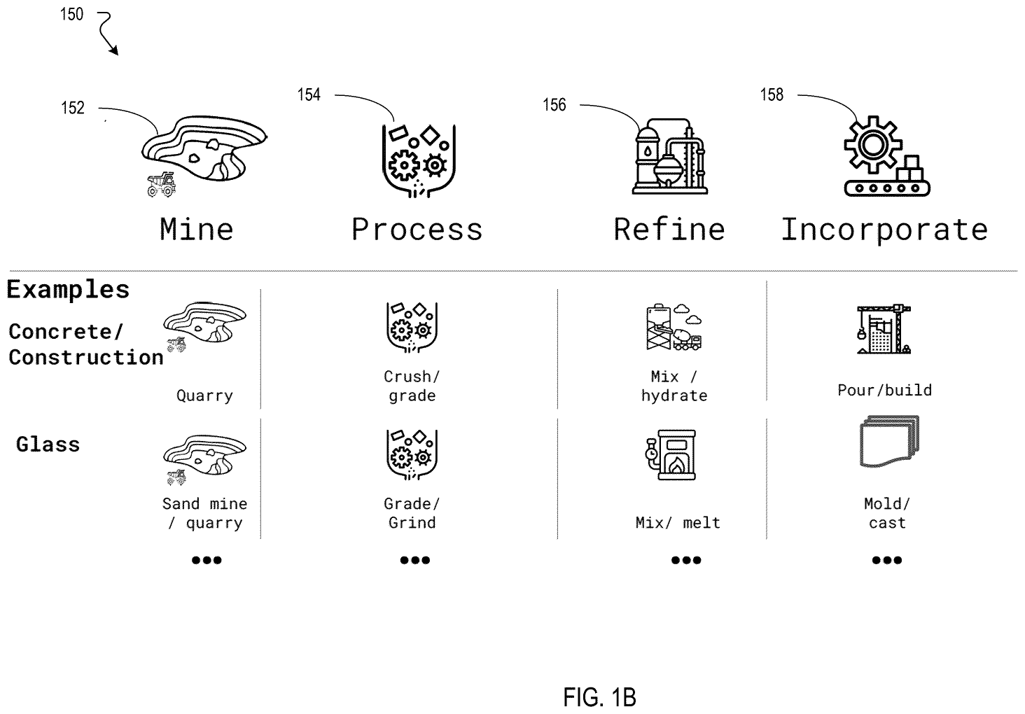

FIG. 1A shows an example operating environment 101 for a materials exchange system 100. The materials exchange system includes an exchange engine 102 and a recipe generation engine 104. The materials exchange system 100 is in data communication with one or more manufacturers 106 and one or more material producers 108. The materials exchange system 100 can be in data communication with manufacturers 106 and material producers 108 over a data communication network, such as a local area network (LAN), wide area network (WAN), the Internet, or a combination thereof.

The materials exchange system 100 is hosted on one or more computers, e.g., one or more servers, for example, one or more cloud-based servers. The materials exchange system 100 includes an application programming interface (API) through which respective computer systems of the manufacturers 106 and material producers 108 can interact with the materials exchange system 100. Additionally, in some instances, the materials exchange system can include a graphical user interface (GUI) through which users, e.g., representatives of the manufacturers 106, material producers 108, or other interested parties, can interact with the materials exchange system 100.

In some implementations, the materials exchange system 100 can be implemented for a particular industry, e.g., to concrete, electronics, metals, etc. For example, the materials exchange system 100 can be a concrete preparation platform for concrete manufacturers and raw material producers, e.g., quarries, to interact through the concrete preparation platform. In another example, the materials exchange system 100 can be a waste materials recycling platform for materials recycling producers to interact with manufacturers who incorporate recycled materials into products. In another example, the materials exchange system 100 can be an ore production platform for manufacturers and raw material producers, e.g., mines, smelters, or other geomaterials processors, to interact to the geomaterials platform.

In some implementations, materials exchange system 100 is an internal API for a manufacturer 106 and one or more integrated material producers 108. For example, a concrete manufacturer and one or more integrated quarries and material processing facilities. In another example, a foundry and one or more integrated geomaterials processing facilities. In some implementations, material exchange system 100 is an external API configured to connect a manufacturer 106 with external material producer(s) 108 and/or multiple manufacturers 106 with external material producer(s) 108. For example, an electronics manufacturer and one or more external material recycling facilities. In another example, a foundry and one or more external geomaterials processing facilities, where the one or more external geomaterials processing facilities can perform an aspect of the geomaterials process, e.g., extraction, refining, smelting, fabrication, etc.

Manufacturers 106 include, for example, entities including material preparation systems 110, for example, a concrete preparation system, slurry preparation system, or another material composition preparation system, where the material preparation systems 110 receive raw ingredients as input and generate mixture output. Manufacturers 106 include, for example, entities involved in the refining processes for ore, e.g., an ore smelting systems, ore hydrometallurgy systems, ore electrolytic refining systems, and the like.

In operation, material preparation systems 110 measure characteristics of one or more of the raw ingredients that are included into the material mixture using collected sensor data 112 from distributed sensors 114 located throughout the production processes of the material preparation system 110, e.g., raw material characterization, processed material composition characterization, slurry characterization, end-product characterization data. For example, material preparation system 110 can include a continuous monitoring process including diverting a representative sample of raw material(s) from a primary stream of system to characterize the material(s). In another example, material preparation system 110 can collect a representative sample from a batch of raw material(s) to characterize the batch in an intermittent (e.g., once-a day) characterization of raw material(s).

The sensor data 112 collected by sensors 114 can be processed by material characterization module 116, where the material preparation system 110 can adaptively adjust proportion(s) of the raw ingredients added into the mixture based in part on an analysis performed by the material characterization module 116 to achieve a set of target properties of the mixture and/or final product more accurately. Target properties of the mixture can include, for example, rheological properties (e.g., flow characteristics) of the mixture. Target properties of the final product can include, for example, structural properties, electrical properties, thermal properties, chemical properties, or the like, of a final product.

Sensors 114 can include various different sensors configured to measure various characteristics of the composition ingredients. For example, the sensors used by the material preparation system 110 can include, but are not limited to, optical sensors (e.g., visible light cameras, hyperspectral cameras, infra-red cameras, dynamic optical microscopy sensors), mechanical sensors (e.g., sieves, sedigraphs, impact hammer, electrodynamic vibrator), and chemical sensors (e.g., mass spectroscopy, chemical tomography, ion-selective electrodes, gas sensors, conductivity sensors, etc.). The measurement data can be used by the material preparation system 110 to determine characteristics of the raw ingredients of the mixture or formula for producing the end-product. For example, ingredient characteristics can include, but are not limited to, particle size, particle shape, particle volume, specific surface area, particle sphericity, composition, color, texture, hardness. Additionally, material preparation system 110 can include various different sensors configured to measure distributions of characteristics across one or more ingredients included in a composition. For example, particle size distributions, specific surface area distributions, particle volume distributions, composition distributions, etc. In some examples, distribution of characteristics can include a distribution of different ore compositions in the raw material.

Sensors 114 can include sensors to provide rheometric measurements of the mixture. For example, the mixture sensors can measure various attributes of the mixture that can be used to estimate or compute rheological properties of the mixture in real-time. Mixture sensors can include, but are not limited to, viscosity sensors, rheometers, temperature sensors, moisture sensors, ultrasonic sensors (e.g., ultrasonic pulse velocity sensors), electrical property sensors (e.g., electrodes, electrical resistance probes), electromagnetic sensors (e.g., short-pulse radar), or other sensors (e.g., geophone, accelerometer). Mixture sensors can include, but are not limited to, hydrophobicity, moisture content, XRD spectra, XRF spectra, static yield stress, acoustic impedance, p-wave speed, dynamic yield stress, static modulus of elasticity, Young's modulus, bulk modulus, shear modulus, dynamic modulus of elasticity (DME), Poisson's ratio, density, resonance frequency, nuclear magnetic resonance (NMR), dielectric constant, electric resistivity, polarization potential, and capacitance. Sensors 114 can include sensors to provide chemical composition measurements of the processed geomaterial(s), for example, pH sensors, conductivity sensors, gas sensors, ion-selective electrodes, optical sensors, temperature sensors, level sensors, etc. As described in more detail below, material preparation system 110 can provide the measured characteristics for the raw materials and mixture composition as feedback to the materials exchange system 100 which can be converted into updated raw material requests 122 for the material producer(s) 108.

Manufacturer 106 includes a production schedule 118, e.g., a forecasted plan of manufacturing. The production schedule 118 can include a list of products, e.g., material compositions, to be manufactured by the material preparation systems 110. Production schedule 118 can include a set of target properties for each of the list of products, e.g., as described above. Manufacturer 106 can generate, from the production schedule, production requests 120 including requests for raw materials, e.g., multiple raw materials, to be incorporated into the production schedule for one or more products and provide the production requests 120 to the material exchange system 100. The production requests 120 can include, for example, a set of end-product parameters, e.g., a set of post-curing product parameters, set of chemical composition parameters, set of mechanical performance parameters, etc. The set of end-product parameters can be used as input to the materials exchange system 100 which can predict, e.g., using one or more trained models and from the set of end-product parameters, a bill of raw materials to obtain the set of end-product parameters.

End-product parameters can depend in part on ASTM standards, the type of product, the materials, etc. For example, the end-product parameters can include, tensile strength, durability, porosity, surface finish, composition, slump, air content, compressive strength, shrinkage, calorimetry, chemical composition, purity, surface finish, etc. Materials exchange system 100 can receive production requests 120 from multiple manufacturers 106.

Exchange engine 102 of the materials exchange system 100 is configured to receive a request for raw materials and/or recipe(s) including raw materials as input and generate, by the production request module 121, the raw material requests 122. The raw material request(s) 122 include one or more requests specifying raw materials and raw material characteristics corresponding to the production request 120. A raw material request 122 can be generated for each raw material corresponding to the production request 120. For example, a raw material request 122 can be generated for each of two or more concrete raw ingredients for a concrete mixture production request 120. In another example, a raw material request 122 can be generated for each of two or more ore-based ingredients for a metals-based production request 120.

In some implementations, a production request 120 from manufacturer 106 specifies one or more raw materials, i.e., specifies a recipe including the raw materials for producing the recipe. For example, a manufacturer 106 can submit to the materials exchange system 100, a production request 120 specifying one or more raw materials including target characteristics of the one or more raw materials such that the production request module 121 generates raw material requests 122 from the production request 120.

In some implementations, recipe generation engine 104 can receive the production request 120 including a set of target material properties for the end product and generate, for the set of target material properties, a corresponding recipe including one or more raw materials to achieve the set of target material properties. For example, a trained machine learning model 124 of the recipe generation engine 104 can be trained on material properties 126 of multiple raw materials, recipes, and end product material properties. The model 124 can receive the production request 120 including the set of target material properties and output a prediction including a recipe 128 corresponding to the set of target material properties and including a set of raw ingredients to produce the recipe.

In some implementations, recipe generation engine generates multiple recipes with respective bills of material responsive to the production request, where each recipe is predicted to result in an end-product meeting the target set of material properties. The recipe generation engine can rank the recipes and corresponding bill of materials to meet certain objectives, e.g., timing of material availability, cost, distance of transport, etc. In some instances, the recipe generation engine can rank recipes based on prioritization schemes for the set of end-product parameters, e.g., ranking a recipe with a higher end material strength versus a recipe with higher end surface finish. The recipe generation engine 104 can output the recipe 128 including the raw materials to the exchange engine 102.

Material sourcing module 130 of the exchange engine 102 determines, for each of the raw material requests 122, the request for raw material having a set of target characteristics a source for the raw material request 122. Material sourcing module 130 receives from material producers 108, an available materials repository 132 including available raw materials produced and/or forecasted for the materials producers 108 and determines, from the materials repository 132, to provide raw material requests 122 to one or more material producers 108.

The materials exchange system 100 can receive from the material producers 108, available materials 132 based on a current and/or forecasted raw materials 140 output of raw material processing system(s) 134 of the material producers 108. Raw material producers 108, e.g., quarries, recycling facilities, mines, etc., include raw material processing systems 134 for refining and/or recycling raw materials and/or recycled materials. For example, raw material processing system can refine raw geomaterial extracted from a quarry to produce raw materials 140 having a set of material characteristics, e.g., particle size distribution, composition, etc. In another example, raw material processing system can refine recycled material, e.g., concrete, asphalt, etc., to reduce the recycled materials into raw materials having a set of material characteristics.

In some implementations, the raw materials used to produce an end-product requires a multi-step process including multiple raw material producers performing a respective process on the material to prepare it for a final end-product. For example, in the production of steel, multiple raw material producers can be involved in extracting, refining, smelting, and otherwise preparing the ore for the production of the steel end-product. In such cases, the materials exchange system 100 can receive available materials from the multiple raw material producers, where material producers engaging in subsequent refinement steps of the production of the end-product can obtain information about raw materials needed for the respective refinement steps. For example, each of the multiple raw material producers can engage with the materials exchange system 100 as described throughout this document, for performing the corresponding step of materials processing in a multi-step process.

Material producers 108 include sensors 136 collecting sensor data 138 of the raw material 140 along various points of the raw material processing system 134. Sensors 136 can be, e.g., as described with reference to sensor data 112, configured to measure various characteristics of the raw materials 140. For example, the sensors used by raw material processing system 134 can include, but are not limited to, optical sensors, chemical sensors, and mechanical sensors. The sensor data 138 can be used by the raw material processing system 134 to determine raw material characteristics of the output of the system 134. For example, raw material characteristics can include, but are not limited to, particle size, particle shape, particle volume, specific surface area, and particle sphericity, particle size distributions, specific surface area distributions, particle volume distributions, chemical composition and distribution, etc.

In some implementations, the material sourcing module 130 receives from the material producers 108, sensor data 138 captured by sensors 136 of the raw materials 140 and processes the sensor data 138 to determine material characteristics of the raw materials 140. The material sourcing module 130 can pre-process the received sensor data, for example, using techniques like Principal Component Analysis (PCA) and/or Random Forest models, to simplify the complexity of the sensor data by reducing a number of variables and identifying the most influential factors.

The materials exchange system 100 can determine, from the sensor data 138 the available materials 132 from the material producers 108. The materials exchange system 100 can enrich the repository of available materials 132 to include forecasted trends in product demand, material usage, etc.

In some implementations, material producer(s) 108 can provide a current and/or forecasted output of raw materials 140 from the raw material processing systems 134 as well as available materials which can be produced, e.g., through further refinement and/or further processing, from the raw materials 140. In other words, the material producer 108 can provide a list of available and/or anticipated output raw materials 140 of the systems 134 as well as a list of secondary raw materials which can be produced from the raw materials 140. For example, the material producer 108 can provide a list of possible raw materials which can be produced from the product that has already been produced and/or is anticipated in production. The material producers 108 can store and update operational parameters 142 for the raw material processing system 134 to adjust an output raw material from the raw material processing system 134.

In some implementations, material producer(s) 108 can provide a forecasted output of raw materials 140 based in part on a processability metric, e.g., a measure of difficulty and/or resources required to process the ore. For example, a mine can extract multiple types of ore, one or more of the extracted types being more processable, e.g., uses fewer resources to refine, and one or more of the extracted types of ore being less processable, e.g., using more resources to refine. Depending on the requirements for the raw materials, the material producer(s) 108 can forecast multiple available outputs of raw materials responsive to processibility metric.

In some implementations, sensors 114, sensors 136, or a combination of both are incorporated into a sensor kit. The sensor kit can be multimodal, e.g., include different types of sensors that are configured to collect different types of sensor data. The sensor kit can be deployable in a production environment including the raw material processing systems 134, the material preparation systems 110, or both. The sensor kit can be modular, e.g., with configurable sensors, depending on the production environment and materials of interest. For example, a sensor kit including multiple sensors deployed in an ore-based geomaterials production environment can include a hyperspectral camera. In another example, a sensor kit including multiple sensors deployed in a concrete-based production environment can include a rheometer.

In some implementations, the material producer 108 can provide multiple permutations of available and/or anticipated output of primary raw materials and secondary raw materials, e.g., if more than one type of material can be produced from a same base source. The material producer 108 can rank the multiple permutations using metrics, for example, cost, quality, timing of availability, volume, processability, process efficiency, and the like. In some instances, the multiple permutations can be ranked based on an anticipated usefulness to the end manufacturer, e.g., least wasteful of resources.

In some implementations, the materials exchange system 100 identifies multiple material producers to obtain a particular raw material. The multiple material producers can be ranked based on ability, skill, or otherwise expertise in producing the particular raw material. For example, the materials exchange system 100 can identify a first ore refinery as having a first degree of expertise in producing a refined ore product from an available extracted ore, and a second ore refinery as having a second, lesser degree of expertise in producing the refined ore product from the available extracted ore and recommend, to the end-product manufacturer to use the first ore refinery as result.

In some implementations, available materials 132 includes additional details related to the materials available from the material producers 108. Additional details can include, for example, cost, location of the material, lead time for delivery of the material, volume, quality factors, range of target characteristics, cleanliness of the particles, percentage of contaminants in the particles, weather/environmental conditions of the quarry, etc.

Exchange engine 102 provides, to a material producer 108, a raw material request 122 for a raw material having a set of target characteristics. The material producer 108, in response to the raw material request 122, can return a fulfillment card 144 in response to raw material request 122 and including fulfillment parameters. Fulfillment parameters can include, for example, lead time, volume, cost, location, material characteristics, etc.

Material source module 130, in response to the fulfillment card 144, can determine to register the fulfillment of the raw material request 122 by the fulfillment card 144. Determining to register the fulfillment can be based upon, for example, at least a threshold matching of the raw material request parameters with the fulfillment parameters of the fulfillment card 144. For example, the material source module 130 can register the fulfillment in response to determining that characteristics of the requested raw material meets a threshold cost, material characteristics, and material quality for the raw material request 122.

In some implementations, the material source module 130 can register the fulfillment in response to determining that characteristics of the requested raw material are within a range of request cost, material characteristics, and material quality for the raw material request 122. For example, the raw material request 122 can include ranges of acceptable values for each request parameter such that the fulfillment parameters should align within the respective ranges of acceptable values.

In some implementations, material sourcing module 130 can determine that none of the currently available materials 132 fulfill the raw material request 122, e.g., none of the raw materials have material characteristics matching or within a threshold tolerance of the raw material request parameters. The material sourcing module 130 can receive operating capabilities of the raw material processing systems 134, for example, based in part on the type of processing system. For example, a coarse aggregate production system, settings can include speed of jaw movement, distance between jaws, jaw angle, etc. Other settings can include e.g., speed of the conveyer belt, volume, crush force, etc. In another example, an ore smelting production system, settings can include temperature, material compatibility, volume, gas sources, etc. The material sourcing module 130 can further determine, based on the available materials 132 and the operating capabilities of the raw material processing systems 134, that one or more of the currently available materials 132 can be further refined by the raw material processing system 134 to produce a new raw material meeting or within a threshold tolerance of the raw material request parameters. For example, the material sourcing module 130 can determine, from available coarse low-value particles, refinements that can produce new high-value fine particles. In another example, the material sourcing module 130 can determine, from available low-quality/low-value raw ore, refinements that can produce new high-quality/high-value refined ore. In such cases, the materials exchange system can provide operational parameters 142 to adjust the operation of the raw material processing system 134 to produce the new raw material in fulfillment of the raw material request 122.

In some implementations, material producers 108 can provide fulfillment cards 144 corresponding to raw materials 140 available and/or forecasted as output from the raw material processing systems 134 to the materials exchange system 100. The materials exchange system 100 can provide, to the manufacturers 106, the fulfillment cards 144 as proposed (i.e., anticipated) raw material requests 122. For example, fulfillment cards 144 can be representative of a current and/or anticipated geomaterial extracted from a quarry by the material producers 108. In another example, fulfillment cards 144 can be representative of current and/or anticipated recyclable materials by the material producers 108.

In some implementations, material producers 108 and/or the materials exchange system 100 can enrich fulfillment cards 144 to specify commodities including how the raw material behaves when used in products. As such, a manufacturer 106 can be a more informed decision on how to use and incorporate the raw material represented by the fulfillment card 144 into a product. For example, materials exchange system 100 can receive the fulfillment cards 144 and provide, to the recipe generation engine 104, the fulfillment cards 144. The recipe generation engine 104 can determine, based on the material properties of the raw materials represented by the fulfillment cards 144, one or more recipes 128 including the raw materials represented by the fulfillment cards 144. The materials exchange system 100 can enrich the fulfillment cards 144 with the available recipes 128 and provide the enriched fulfillment cards 144 to the manufacturers 106 as potential product(s) to include in production schedule 118.

In some implementations, one or more processes described in this specification are performed in real-time. For example, the materials exchange system 100 can update an output from the raw materials processing system 134 based on feedback from the manufacturer 106. In another example, the materials exchange system 100 can perform real-time allocation of resources, e.g., of the available materials 132, based on real-time production requests 120 from manufacturers 106.

In some implementations, materials exchange system 100 can facilitate real-time production feedback 146 between manufacturers 106 and material producers 108. For example, production feedback can include material characterization by material characterization module 116 from the sensor data 112 collected by sensors 114 of processes of material preparation system 110 including raw materials. The materials preparation system 110 can provide the production feedback 146 to the material producer(s) 108 that provided the raw materials used in the processes. For example, production feedback 146 can indicate that one or more of the raw materials is out of specification, e.g., has material properties different than requested properties, or is behaving differently in the recipe than expected. In other words, the materials exchange system 100 can use sensor data 112, 138 to generate a set of operational parameters 142 for the raw materials processing system 134, set prices, market making, to best meet demands from the production requests 120.

In some implementations, a material producer 108 can receive the production feedback 146 and generate updated operational parameters 142 to alter the output of the raw material processing system 134. The production feedback, e.g., rheological measurements, end-product properties, etc., can be used to calibrate the sensors of the material producers. For example, to compensate for drift and recalibrate the operation parameters, and/or to refine the characterization of the raw material, e.g., based on how the slurry behaves, based on a chemical composition of the refined ore, etc. The production feedback can be used to adjust how the raw material producers interpret the sensor data of the raw materials, e.g., optical characterization of a particle size distribution and/or material composition. In order to isolate and calibrate only the material producer's sensors, the operational parameters of the end-product manufacturers can be held constant. This can ensure that any observed changes in the product's properties are solely attributable to variations in the material processing, which are then measured by the sensors. For example, to run a crusher system faster/slower, run a conveyer belt faster/slower, etc. In another example, to adjust a temperature of a smelting process, or the like.

In some implementations, production feedback is provided in real-time from the manufacturer 106 to the material producer 108. For example, production feedback can indicate, in real-time, that the output of a raw material processing system 134 has drifted, such that the material producers 108 can respond by updating operational parameters 142 of the raw material processing system 134 to adjust, e.g., recalibrate, the system 134. As such, the material producers 108 can update the output of raw materials 140 based on demand/feedback from the manufacturers 106 which in turn can facilitate fine adjustments of raw material in order to produce product within the specification.

In some implementations, production feedback is generated by the material producers 108 in response to sensor data collected by sensors 136 of the raw material processing system 134. Sensor data 138 can indicate that a composition, e.g., a geology, of the raw material is changing such that the material producer 108 can update operational parameters 142 to adjust performance of the raw material processing system 134 to compensate. For example, in response to sensor data 138 indicating that the raw materials are processing differently, e.g., breaking differently, the operational parameters 142 can be updated such that the raw material processing system 134 continues to output raw material 140 usable by manufacturers 106.

In some implementations, the materials exchange system 100 can track and identify shifts in demand for raw materials 140 produced by the material producers 108. In response, the materials exchange system 100 can notify the material producers 108 to adjust production of the less in-demand raw materials. Alternatively, or additionally, the materials exchange system 100 can engage with the recipe generation engine 104, e.g., as described above, to repurpose or otherwise find alternate uses for raw materials 140 that are less in-demand.

In some implementations, the materials exchange system 100 includes predictive modeling to forecast raw material demand, optimize inventory usage, and reduce waste and unused raw materials. For example, the materials exchange system 100 can use a predictive model to optimize the output of the material producers 108 based on how the raw materials 140 align with demand from manufacturers 106. In another example, the system uses a predictive model to perform a cost-benefit analysis of an additional process run by raw material processing system 134 on unused raw materials 140 to produce a more in-demand secondary raw material product.

In some implementations, the materials exchange system 100 is implementable as an internal API to allow an integrated manufacturer 106 to track a repository of leftover raw materials in order to repurpose the leftover materials and reduce waste.

In some implementations, the materials exchange system 100 is implementable by chemical and/or electronics manufacturers to source recyclable electronic waste isolate materials for recycling/reuse. In other words, the materials exchange system 100 can inform how the processing of recyclable materials is performed to obtain an end product, where the processing is fine-tuned for a specific order rather than for an average market demand.

As described with reference to FIG. 1A, the materials exchange system 100 is implementable by a variety of industries, e.g., industries involved in different geomaterial extraction, processing, refining, and incorporation into end product. FIG. 1B shows an example block diagram 150 of a process of the materials exchange system for various industries. The materials exchange system 100 can be used to facilitate the step of mining 152 the geomaterials. Mining of geomaterials can include, for example, extracting raw materials from a quarry or mine, e.g., an ore mine or a rock quarry. For example, for a concrete/construction industry, the mining includes extracting raw materials from a quarry. In another example, for a glass industry, the mining includes extracting raw materials from a sand mine/quarry.

The materials exchange system 100 can be used to facilitate the step of processing 154 the geomaterials. Processing geomaterials can include, for example, reducing the size, separating the raw materials, e.g., by size, shape, composition, or the like. For example, for a concrete/construction industry, the processing includes crushing and/or grading the raw materials. In another example, for a glass industry, the processing includes grading and/or grinding of the raw materials.

The materials exchange system 100 can be used to facilitate the step of refining 156 of the geomaterials. Refining the geomaterials can include, for example, one or more chemical and/or thermal processes to further process the geomaterials to a state which can be used by end product manufacturers. For example, for a concrete/construction industry, the refining includes mixing and/or hydrating the raw materials. In another example, for a glass industry, the mining includes mixing and/or melting the raw materials.

The materials exchange system 100 can be used to facilitate the step of incorporating 158 the geomaterials into an end product. Incorporating the geomaterials into an end product can include, for example, incorporating the geomaterials into a manufactured composite mixture, e.g., slurry mixture, a manufactured molded or cast product, a manufactured three-dimensional printed product, or the like. For example, for a concrete/construction industry, the incorporating includes incorporating the raw materials into poured concrete, e.g., building materials. In another example, for a glass industry, the incorporating includes incorporating the raw materials into molded and/or cast products.

Although described with reference to FIG. 1B as four steps: mine 152, process 154, refine 156, and incorporate 158, one or more of the steps can be multi-step processes. In some instances, one or more of the steps can be performed by the same entity. In some examples, all of the steps are performed by a same entity, e.g., an integrated concrete manufacturer where the different steps can be coordinated through the API of the materials exchange system 100. In some instances, one or more of the steps can be performed by different entities. In some examples, each of the steps and/or sub-steps are performed by different entities, where the different entities interact through an API of the materials exchange system 100.

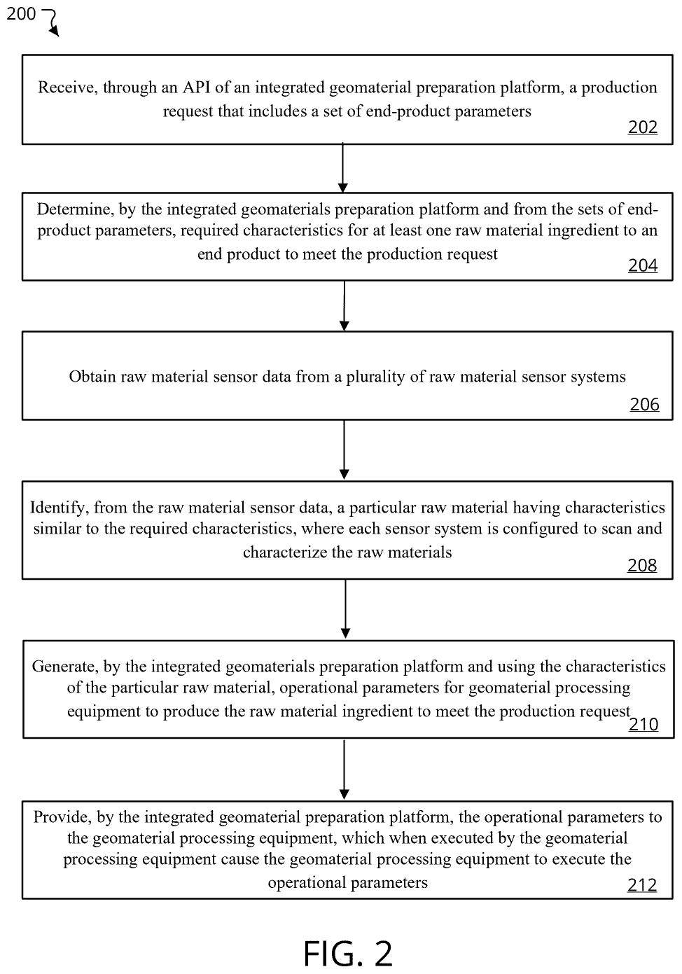

FIG. 2 is a flow diagram of an example process 200 of the materials exchange system 100. As discussed above, the materials exchange system 100 can be implemented for a particular industry, e.g., a particular geomaterials industry. For example, concrete manufacturing or ore-based manufacturing. The process 200 of the materials exchange system 100 therefore is described in terms of an implementation of an integrated geomaterial preparation platform. The processes 200 can be applied generally to the materials exchange system 100 across different industries. For convenience, the process 200 will be described as being performed by a system of one or more computers, located in one or more locations, and programmed appropriately in accordance with this specification. At 202, an integrated geomaterial preparation platform receives, through an API of the integrated geomaterial preparation platform, a production request that includes a set of end-product parameters, e.g., post-curing product parameters. The production request, e.g., production request 120, can be provided by a manufacturer 106, based on a production schedule 118 of the manufacturer. The production request includes a set of end-product parameters, e.g., composition, density, porosity, tensile strength, etc., for the end product.

At 204, the integrated geomaterial preparation platform determines, from the set of end-product parameters, required characteristics for at least one raw material ingredient to an end product, e.g., a concrete mixture, refined ore, etc., to meet the production request. A recipe generation engine, e.g., recipe generation engine 104 of the integrated geomaterial preparation platform can receive the set of end-product parameters and determine, based on prediction of a trained machine learning model, e.g., ML 124, a recipe 128 to produce the set of end-product parameters. For example, the integrated geomaterial preparation platform can receive a set of post-subring product parameters for the concrete product and determine, based on prediction of a trained machine learning model, e.g., ML 124, a recipe 128 to produce the set of post-curing product parameters. The recipe 128 includes a set of one or more raw material ingredients for the end product and corresponding material characteristics for the raw material ingredients.

At 206, the integrated geomaterial preparation platform obtains raw material sensor data from a plurality of raw material sensor systems. The integrated geomaterial preparation platform can receive sensor data from distributed sensor systems in a raw material processing system of a material producer, e.g., sensor data 138 collected by sensors 136 located at a raw material processing system 134 of a material producer 108. The sensors 136 can be arranged with respect to a processing line of the raw material processing system 134 to collect information related to the material characteristics of raw materials being processed by the raw material processing system 134. Sensors 136 can include, for example, an optical characterization system configured to capture image data of particles of the raw material to characterize material characteristics of the particles, e.g., composition, surface aspect ratio, surface area, etc.

At 208, the integrated geomaterial preparation platform identifies, from the raw material sensor data, a particular raw material having characteristics similar to the required characteristics, where each sensor system is configured to scan and characterize particles of raw materials. A material sourcing module of the integrated geomaterial preparation platform, e.g., material sourcing module 130 of the exchange engine 102 of the system 100, can identify from the raw material sensor data 138 of the raw materials 140 output from material producer 108, a particular raw material having characteristics similar, e.g., at least a threshold similarity, to the requested material characteristics of the raw materials request 122 generated from the production request 120.

In some implementations, a manufacturer 106 can specify tolerances for different material characteristics for different materials being requested. For example, a manufacturer can specify a range of sizes for a first raw material that are within a threshold acceptable range for the first raw material. In another example, a manufacturer can specify a maximum and/or minimum distribution width for a distribution of particles for a second raw material. In another example, instead of targeting single values, manufacturers can define acceptable ranges for both multiple properties. A model can then generate formulations, e.g., combinations of raw materials and processes, that yield the end product meeting the specified material characteristics, e.g., meeting both the specified strength and flowability ranges. The integrated geomaterial preparation platform can rely on manufacturer-specified and/or default tolerances to determine whether a raw material 140 from the material producer 108 meets the threshold criteria of the raw materials request 122 for the production request 120.

At 210, the integrated geomaterial preparation platform generates, using the characteristics of the particular raw material, operational parameters for geomaterial processing equipment to produce the raw material ingredient to meet the production request. In some implementations, as discussed above, the integrated geomaterial preparation platform can determine that further processing is required to obtain the raw material meeting the threshold criteria of the raw materials request 122. The material sourcing module 130 can generate, for the material characteristics of the raw materials request 122 a set of operational parameters 142 for the raw material processing system 134 to process an existing raw material 140 into the target raw material corresponding to the request 122. For example, the operational parameters can cause the raw material processing system to speed up/slow down a conveyer belt of raw material through the breaking process to yield different size distribution of rock. In another example, the operational parameters can cause the raw material processing system to increase/decrease a temperature of a smelting process to yield a different alloy composition and/or microstructure of the smelted orc.

In some implementations, the material sourcing module 130 can integrate a trained machine learning model operable to receive operating capability of the raw material processing system 134, material characteristics of raw materials 140, and target material characteristics for the requested raw material, and output a set of operational parameters for the raw material processing system to process the raw material to obtain the target material characteristics.

At 212, the integrated geomaterial preparation platform provides the operational parameters to the geomaterial processing equipment, which when executed by the geomaterial processing equipment cause the geomaterial processing equipment to execute the operational parameters. As described with reference to FIG. 1A, the integrated platform can provide a notification to the manufacturer to confirm fulfillment of the production request 120, e.g., as a fulfillment card 144.

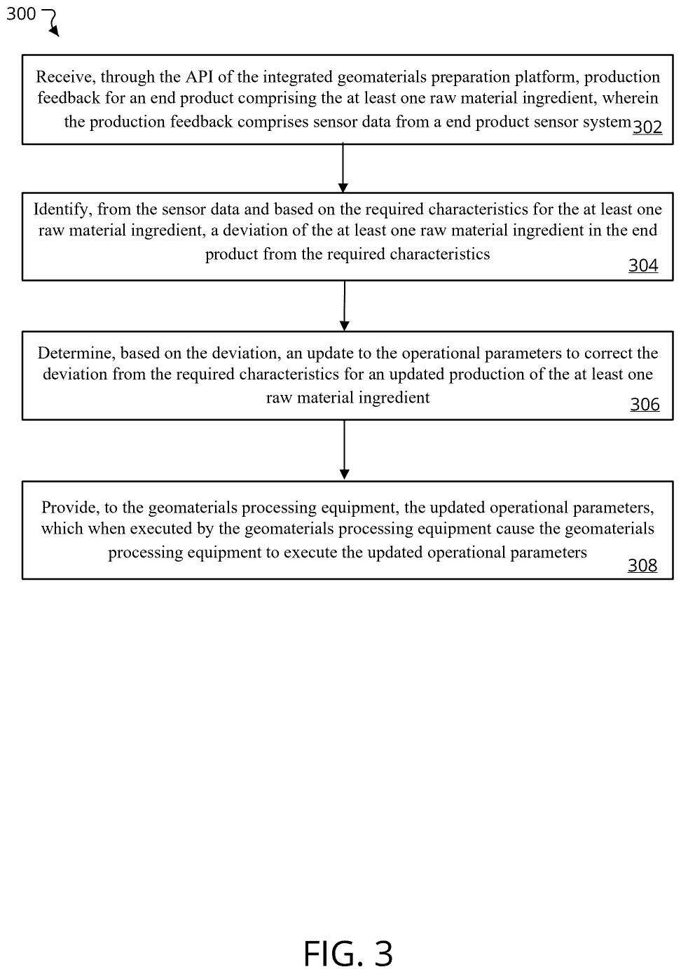

FIG. 3 is a flow diagram of an example process of the integrated geomaterial preparation platform. As discussed above, the materials exchange system 100 can be implemented for a particular industry, e.g., concrete manufacturing, ore-based manufacturing. The process 300 of the materials exchange system 100 therefore is described in terms of an implementation of an integrated geomaterial preparation platform. The processes 300 can be applied generally to the materials exchange system 100 across different industries. For convenience, the process 300 will be described as being performed by a system of one or more computers, located in one or more locations, and programmed appropriately in accordance with this specification. At 302, the integrated geomaterial preparation platform receives, through the API, production feedback for an end product, e.g., a concrete mixture, including at least one raw material ingredient. The production feedback includes mixture sensor data from a mixture sensor system. For example, as described with reference to FIG. 1A, material preparation system 110 includes distributed sensors 114 throughout a production line of the material preparation system 110, where sensor data 112 is collected of the end product during the preparation processes. The sensor data 112 can be collected in-line with the preparation system and/or a sample can be collected and characterized separately from the preparation system. In either case, the sensors 114 can characterized the raw material ingredients and/or end product, e.g., a material formulation, mixture, composite, etc.

At 304, the integrated geomaterial preparation platform identifies, from the mixture sensor data and based on the required characteristics for the at least one raw material ingredient, a deviation of the at least one raw material ingredient in the end product from the required characteristics. For example, a material characterization module 116 of the material preparation system can provide the production feedback 146 to the integrated geomaterial preparation platform where the material sourcing module 130 can process the production feedback 146 including sensor data 112 to identify a deviation of material characteristic(s) from the targeted material characteristics for the raw material ingredient.

In some implementations, some, or all of the analysis of the sensor data 112 for the production feedback 146 is performed by a material characterization module 116, e.g., to translate sensor data 112 into material characteristics for the raw material and/or end product. In such cases, the material characterization module 116 can provide a production feedback including the analysis to the integrated geomaterial preparation platform for further processing.

At 306, the integrated geomaterial preparation platform determines, based on the deviation, an update to the operational parameters to correct the deviation from the required characteristics for an updated production of the at least one raw material ingredient. For example, the materials sourcing module 130 can determine updates to the operation of the raw materials processing system 134 to cause the raw material output from the raw materials processing system 134 to be within specification, e.g., to match or be within tolerance of the requested/targeted material characteristics of the raw material ingredient.

At 308, the integrated geomaterial preparation platform provides, to the geomaterial processing equipment, the updated operational parameters, which when executed by the geomaterial processing equipment cause the geomaterial processing equipment to execute the updated operational parameters.

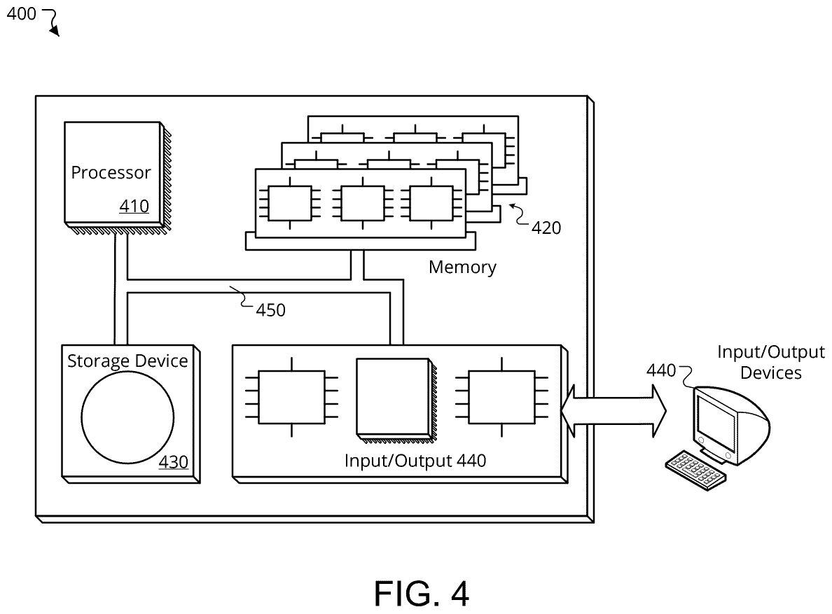

FIG. 4 is a schematic diagram of a computer system 400. The system 400 can be used to carry out the operations described in association with any of the computer-implemented methods described previously, according to some implementations, for example, the operations described with respect to materials exchange system 100. In some implementations, computing systems and devices and the functional operations described in this specification can be implemented in digital electronic circuitry, in tangibly-embodied computer software or firmware, in computer hardware, including the structures disclosed in this specification (e.g., system 400) and their structural equivalents, or in combinations of one or more of them. The system 400 is intended to include various forms of digital computers, such as laptops, desktops, workstations, personal digital assistants, servers, blade servers, mainframes, and other appropriate computers, including vehicles installed on base units or pod units of modular vehicles. The system 400 can also include mobile devices, such as personal digital assistants, cellular telephones, smartphones, and other similar computing devices. Additionally, the system can include portable storage media, such as, Universal Serial Bus (USB) flash drives. For example, the USB flash drives may store operating systems and other applications. The USB flash drives can include input/output components, such as a wireless transducer or USB connector that may be inserted into a USB port of another computing device.

The system 400 includes a processor 410, a memory 420, a storage device 430, and an input/output device 440. Each of the components 410, 420, 430, and 440 are interconnected using a system bus 450. The processor 410 is capable of processing instructions for execution within the system 400. The processor may be designed using any of a number of architectures. For example, the processor 410 may be a CISC (Complex Instruction Set Computers) processor, a RISC (Reduced Instruction Set Computer) processor, or a MISC (Minimal Instruction Set Computer) processor.

In one implementation, the processor 410 is a single-threaded processor. In another implementation, the processor 410 is a multi-threaded processor. The processor 410 is capable of processing instructions stored in the memory 420 or on the storage device 430 to display graphical information for a user interface on the input/output device 440.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 may be a floppy disk device, a hard disk device, an optical disk device, or a tape device.

The input/output device 440 provides input/output operations for the system 400. In one implementation, the input/output device 440 includes a keyboard and/or pointing device. In another implementation, the input/output device 440 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a sub-system, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer. Additionally, such activities can be implemented via touchscreen flat-panel displays and other appropriate mechanisms.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include a local area network (“LAN”), a wide area network (“WAN”), peer-to-peer networks (having ad-hoc or static members), grid computing infrastructures, and the Internet.

The computer system can include clients and servers. A client and server are generally remote from each other and typically interact through a network, such as the described one. The relationship of client and server arises by virtue of computer programs running on the respective computers and having a client-server relationship to each other.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

As used herein, the term “ready mix” refers to concrete that is batched for delivery from a central plant instead of being mixed on a job site. Typically, a batch of ready mix is tailor-made according to the specifics of a particular construction project and delivered in a plastic condition, usually in cylindrical trucks often referred to as “concrete mixers”.

As used herein, the term “real-time” refers to transmitting or processing data without intentional delay given the processing limitations of a system, the time required to accurately obtain data, and the rate of change of the data. Although there may be some actual delays, the delays are generally imperceptible to a user.

What is claimed is:

1. An integrated geomaterials preparation method:
receiving, through an API of an integrated geomaterial preparation platform, a raw material request and a set of end-product parameters for an end product;
determining, by the integrated geomaterial preparation platform and from the set of end-product parameters, required characteristics for at least one raw material ingredient to an end product to meet the raw material request;
obtaining raw material sensor data from a plurality of raw material sensor systems;
identifying, from the raw material sensor data, a particular raw material having characteristics similar to the required characteristics, where each sensor system is configured to scan and characterize particles of raw materials;
generating, by the integrated geomaterial preparation platform and using the characteristics of the particular raw material, operational parameters for geomaterial processing equipment to produce the raw material ingredient to meet the raw material request; and
providing, by the integrated geomaterial preparation platform, the operational parameters to the geomaterial processing equipment, which when executed by the geomaterial processing equipment cause the geomaterial processing equipment to execute the operational parameters.

2. The method of claim 1, further comprising:
receiving, through the API of the integrated geomaterial preparation platform, production feedback for an end product comprising the at least one raw material ingredient, wherein the production feedback comprises mixture sensor data from a mixture sensor system;
identifying, from the mixture sensor data and based on the required characteristics for the at least one raw material ingredient, a deviation of the at least one raw material ingredient in the end product from the required characteristics;
determining, based on the deviation, an update to the operational parameters to correct the deviation from the required characteristics for an updated production of the at least one raw material ingredient; and
providing, to the geomaterial processing equipment, the updated operational parameters, which when executed by the geomaterial processing equipment cause the geomaterial processing equipment to execute the updated operational parameters.

3. The method of claim 1, wherein determining required characteristics for the at least one raw material ingredient to an end product to meet the raw material request comprises:
providing, to a trained machine learning model, the set of end-product parameters;
obtaining, from the trained machine learning model, a recipe including the at least one raw material ingredient corresponding to a finished product having the set of end-product parameters; and
generating, from the recipe, the raw material request for the at least one raw material ingredient.

4. The method of claim 1, wherein obtaining raw material sensor data from the plurality of raw material sensor systems comprises:
receiving one or more of image data captured by an optical imaging sensor system and mechanical data captured by a mechanical sensor system.

5. The method of claim 1, wherein identifying, from the raw material sensor data, the particular raw material having characteristics similar to the required characteristics comprises, for each of the required characteristics:
determining, for the required characteristic, that the particular raw material has a corresponding characteristic within a tolerance for the required characteristic.

6. The method of claim 1, wherein generating operational parameters for geomaterial processing equipment to produce the raw material ingredient to meet the raw material request comprises:
obtaining, for the geomaterial processing equipment, operating capabilities of the geomaterial processing equipment; and
generating control signals that cause the geomaterial processing equipment to update one or more operational parameters within the operating capabilities of the geomaterial processing equipment.

7. The method of claim 1, wherein the end product is one or more of (i) a concrete mixture, (ii) an ore-based product, or (iii) a recycled-material-based product.

8. A system for integrated geomaterials preparation comprising:
one or more computers and one or more storage devices on which are stored instructions that are operable, when executed by the one or more computers, to cause the one or more computers to perform operations comprising:
receive, through an API of an integrated geomaterial preparation platform, a raw material request and a set of end-product parameters for an end product;
determine, by the integrated geomaterial preparation platform and from the set of end-product parameters, required characteristics for at least one raw material ingredient to an end product to meet the raw material request;
obtain raw material sensor data from a plurality of raw material sensor systems;
identify, from the raw material sensor data, a particular raw material having characteristics similar to the required characteristics, where each sensor system is configured to scan and characterize particles of raw materials;
generate, by the integrated geomaterial preparation platform and using the characteristics of the particular raw material, operational parameters for geomaterial processing equipment to produce the raw material ingredient to meet the raw material request; and
provide, by the integrated geomaterial preparation platform, the operational parameters to the geomaterial processing equipment, which when executed by the geomaterial processing equipment cause the geomaterial processing equipment to execute the operational parameters.

9. The system of claim 8, further comprising:
receiving, through the API of the integrated geomaterial preparation platform, production feedback for an end product comprising the at least one raw material ingredient, wherein the production feedback comprises mixture sensor data from a mixture sensor system;
identifying, from the mixture sensor data and based on the required characteristics for the at least one raw material ingredient, a deviation of the at least one raw material ingredient in the end product from the required characteristics;
determining, based on the deviation, an update to the operational parameters to correct the deviation from the required characteristics for an updated production of the at least one raw material ingredient; and
providing, to the geomaterial processing equipment, the updated operational parameters, which when executed by the geomaterial processing equipment cause the geomaterial processing equipment to execute the updated operational parameters.

10. The system of claim 8, wherein determining required characteristics for the at least one raw material ingredient to an end product to meet the raw material request comprises:
providing, to a trained machine learning model, the set of end-product parameters;
obtaining, from the trained machine learning model, a recipe including the at least one raw material ingredient corresponding to a finished product having the set of end-product parameters; and
generating, from the recipe, the raw material request for the at least one raw material ingredient.

11. The system of claim 8, wherein obtaining raw material sensor data from the plurality of raw material sensor systems comprises:
receiving one or more of image data captured by an optical imaging sensor system and mechanical data captured by a mechanical sensor system.

12. The system of claim 8, wherein identifying, from the raw material sensor data, the particular raw material having characteristics similar to the required characteristics comprises, for each of the required characteristics:
determining, for the required characteristic, that the particular raw material has a corresponding characteristic within a tolerance for the required characteristic.

13. The system of claim 8, wherein generating operational parameters for geomaterial processing equipment to produce the raw material ingredient to meet the raw material request comprises:
obtaining, for the geomaterial processing equipment, operating capabilities of the geomaterial processing equipment; and
generating control signals that cause the geomaterial processing equipment to update one or more operational parameters within the operating capabilities of the geomaterial processing equipment.

14. The system of claim 8, wherein the end product is one or more of (i) a concrete mixture, (ii) an ore-based product, or (iii) a recycled-material-based product.

15. One or more non-transitory computer storage media encoded with computer program instructions that when executed by one or more computers cause the one or more computers to perform operations comprising:
receiving, through an API of an integrated geomaterial preparation platform, a raw material request and a set of end-product parameters for an end product;
determining, by the integrated geomaterial preparation platform and from the sets of end-product parameters, required characteristics for at least one raw material ingredient to an end product to meet the raw material request;
obtaining raw material sensor data from a plurality of raw material sensor systems;
identifying, from the raw material sensor data, a particular raw material having characteristics similar to the required characteristics, where each sensor system is configured to scan and characterize particles of raw materials;
generating, by the integrated geomaterial preparation platform and using the characteristics of the particular raw material, operational parameters for geomaterial processing equipment to produce the raw material ingredient to meet the raw material request; and
providing, by the integrated geomaterial preparation platform, the operational parameters to the geomaterial processing equipment, which when executed by the geomaterial processing equipment cause the geomaterial processing equipment to execute the operational parameters.

16. The one or more non-transitory computer storage media of claim 15, further comprising:
receiving, through the API of the integrated geomaterial preparation platform, production feedback for an end product comprising the at least one raw material ingredient, wherein the production feedback comprises mixture sensor data from a mixture sensor system;
identifying, from the mixture sensor data and based on the required characteristics for the at least one raw material ingredient, a deviation of the at least one raw material ingredient in the end product from the required characteristics;
determining, based on the deviation, an update to the operational parameters to correct the deviation from the required characteristics for an updated production of the at least one raw material ingredient; and
providing, to the geomaterial processing equipment, the updated operational parameters, which when executed by the geomaterial processing equipment cause the geomaterial processing equipment to execute the updated operational parameters.

17. The one or more non-transitory computer storage media of claim 15, wherein determining required characteristics for the at least one raw material ingredient to an end product to meet the raw material request comprises:
providing, to a trained machine learning model, the set of end-product parameters;
obtaining, from the trained machine learning model, a recipe including the at least one raw material ingredient corresponding to a finished product having the set of end-product parameters; and
generating, from the recipe, the raw material request for the at least one raw material ingredient.

18. The one or more non-transitory computer storage media of claim 15, wherein obtaining raw material sensor data from the plurality of raw material sensor systems comprises:
receiving one or more of image data captured by an optical imaging sensor system and mechanical data captured by a mechanical sensor system.

19. The one or more non-transitory computer storage media of claim 15, wherein identifying, from the raw material sensor data, the particular raw material having characteristics similar to the required characteristics comprises, for each of the required characteristics:
determining, for the required characteristic, that the particular raw material has a corresponding characteristic within a tolerance for the required characteristic.

20. The one or more non-transitory computer storage media of claim 15, wherein generating operational parameters for geomaterial processing equipment to produce the raw material ingredient to meet the raw material request comprises:
obtaining, for the geomaterial processing equipment, operating capabilities of the geomaterial processing equipment; and
generating control signals that cause the geomaterial processing equipment to update one or more operational parameters within the operating capabilities of the geomaterial processing equipment.
